(19) United States
(12) Patent Application Publication
(10) Pub. No.: US 2020/0262097 A1
(43) Pub. Date: Aug. 20, 2020

(54) QUICK-CHANGE DEVICE

(71) Applicant: James Nassios, Tustin, CA (US)

(72) Inventor: James Nassios, Tustin, CA (US)

(21) Appl. No.: 16/793,421

(22) Filed: Feb. 18, 2020

Related U.S. Application Data
(60) Provisional application No. 62/807,976, filed on Feb. 20, 2019.

(51) Int. Cl. B27B 5/32

(52) U.S. Cl. CPC B27B 5/32

(57) ABSTRACT

A quick-change device for a rotary power tool, such as a circular saw, comprising: a grip hub; a threaded bolt; a bolt key; wherein the bolt key is connected to the threaded bolt, such that the bolt key has at least an extended position and a collapsed position; wherein the threaded bolt is configured to pass through a bolt hole of the grip hub and threadably connect to a spindle of a circular saw; wherein the bolt key is configured to be able to be unscrewed from the spindle when in the extended position, such that an external tool is not needed to remove the threaded bolt from the spindle; wherein the bolt key is configured to matingly stow next to the grip hub when the bolt key is flipped down into the collapsed position; and wherein the threaded bolt may be quickly and safely removed and reengaged for the purpose of switching one or more saw blades.

### CROSS-REFERENCE TO RELATED APPLICATIONS

This application claims the benefit of U.S. Provisional Application No. 62/807,976, filed on Feb. 20, 2019, entitled “Quick-Change Device”, the contents of which are incorporated herein by reference as though set forth in their entirety.

### FIELD

The present disclosure relates generally to devices and methods for a quick-release mechanism for use with power tools, and more particularly with rotary power tools, such as a circular saw.

### BACKGROUND

A circular saw is a power-saw that uses a toothed or abrasive disc or blade to cut different materials using a rotary motion spinning around an arbor. Typically, changing out the blade of a standard saw is a time consuming and inefficient process that includes the steps of: (1) unplug the saw's power cord from the electrical outlet or extension cord, or, remove the battery if it's a cordless saw; (2) pressing down on the saw's arbor-lock button and rotate the blade until the locking mechanism engages; (3) using the blade wrench to remove the arbor nut holding the blade in place; to loosen the nut, turn the wrench in the same direction as the blade cuts; (4) retracting the saw's upper blade guard and remove the old blade; (5) slipping the new blade onto the saw's arbor, making sure the saw teeth face in the direction of rotation; (6) using the blade wrench to tighten the arbor nut until it's snug; be careful not to over-tighten the nut or it'll be difficult to loosen it the next time you change the blade; and (7) straddling the blade, if the saw has a diamond-shaped arbor, over two wood blocks and use a hammer or punch to tap out the diamond insert from the center of the saw blade.

What is needed is an improved, quick-change device for more quickly changing out blades of a power saw or other type of rotary power tool.

### SUMMARY OF ILLUSTRATIVE EMBODIMENTS

To minimize the limitations in the cited references, and to minimize other limitations that will become apparent upon reading and understanding the illustrative embodiments, the present disclosure teaches a new and useful quick-change device for a power tool.\

The present disclosure is related to devices and systems for implementing a quick-release mechanism for use with power tools, namely, circular saws. The quick-release mechanism may allow for an easier, faster, and more efficient removal and replacement of circular saw blades, without requiring the use of any specialized tools (or, as preferred, without requiring the use of any tools at all). Normal circular power saws incorporate a circular saw blade that may be replaced or changed out. This replacement is normally done by locking the blade so it cannot rotate, and then using a key or other specialized tool to loosen and remove a mounting bolt. Once the mounting bolt is removed, then the blade can be removed from the saw. A new blade many then be inserted, and the bolt is re-engaged and tightened (typically using a special tool).

In one embodiment the device may have a wing tip bolt, wherein the bolt's head folds flat into a hub, and a user may flip out the wing tip and use their hands to unscrew the bolt. When folded flat, the wing tip of the bolt is matingly surrounded by a notch that substantially prevents the wing tip from moving circularly in contrast to the hub. Additionally, the act of folding the wing tip down may result in a locking mechanism being engaged that substantially locks the bolt into place and prevents it from accidentally being loosened.

In another embodiment, the device may have a flip locking mechanism, similar to that used in bicycle front wheels/forks, which may allow for complete unscrewing of a bolt, similar to the above embodiment.

Another embodiment may have a wing tip spring lock bolt comprising a wing tip that may fold flat into a hub, a spring, and threaded portion. This spring lock bolt, when pulled against the force of the spring, may reduce the friction holding the circular saw blade in place, allowing for a notched circular saw blade to be removed by sliding the blade out. Regarding this embodiment, a modified circular saw blade may be used so that the locking mechanism need not be completely removed in order to replace the blade. Specifically, a circular saw blade may have a channel extending from its center to the outside of the blade such that when friction holding the blade in place is decreased, a user may simply slide out the circular saw blade, slide in a new blade, and then re-engage the locking mechanism by releasing the spring.

One embodiment is a device for rapidly changing the state of a device from a locked to an unlocked position. The device may include an inner member that slides and is contained in an outer member. The unit may be connected to a manual part that is manually controlled and the other end is connected to a control for changing the device's state. A latch mechanism may hold the two members locked together so that the manual control action responds only to a manual release.

The quick-change device of the present disclosure may rapidly lock and unlock, or engage or disengage, a removeable and wearable part of a power tool. Having a quick-change portion is desirable when changing out blades for cutting saws uses to cut hard materials, such as stone, brick, block, concrete, and/or steel. In addition to providing quickness and efficiency, being able to quickly remove a saw blade may save lives when used in a portable setting.

In various embodiments, power tools with the quick release locking hub system may have composite, carbon fiber, fiberglass, or aramid parts that may replace the metal housing and plastic shrouds. This preferably makes the saw lighter and stronger.

In various embodiments, the inner and outer release may be slideably contained in the housing of the power tool, in this case a saw. The inner and outer parts may be releaseably interconnected via retractable bolts that are moveably contained with the housing of the saw. The locking system may lock the bolts when extended and may be engaged to the lock by turning the quick-change release counter-clockwise and to unlock the quick release by extending the bolt and to disengage the lock to remove the hub and blade from the saw by turning the release clockwise, thus releasing the bolt from the saw.

A bulkhead sleeve or cap may be mounted or fixed in the casing that accepts the quick-release device when engaging the locking system. Both portions may be threaded on and, when moving, the bolt counterclockwise causes the lock to close. Moving the bolt clockwise may cause the lock to open and to be removed so that the saw blades may be swapped out in an easy, efficient, and safe manner.

Other features and advantages are inherent in the compartment divider assembly claimed and disclosed will become apparent to those skilled in the art from the following detailed description and its accompanying drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an exploded perspective view of one embodiment of the quick-change device.

FIG. 2 is a front view of one embodiment of the quick-change device.

FIG. 3 is a side view of one embodiment of the quick-change device.

FIG. 4 is a side view of one embodiment of the quick-change device connected to a circular saw.

FIG. 5 is a perspective view of one embodiment of the quick-change device showing how the bolt key allows the user to unscrew the bolt without an external tool.

FIG. 6 is a close-up side view of a second embodiment of the quick-change device with a cam key.

FIG. 7 is an exploded perspective view of a second embodiment of the quick-change device.

FIG. 8 is a close-up side view of a third embodiment of the quick-change device.

FIG. 9 is an exploded perspective view of a third embodiment of the quick-change device.

### DETAILED DESCRIPTION OF THE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the present disclosure will become apparent to those skilled in the art from the following detailed description, which shows and describes illustrative embodiments of the present disclosure. As will be realized, the device of the present disclosure is capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the present disclosure shall not be interpreted to limit the scope of the present disclosure.

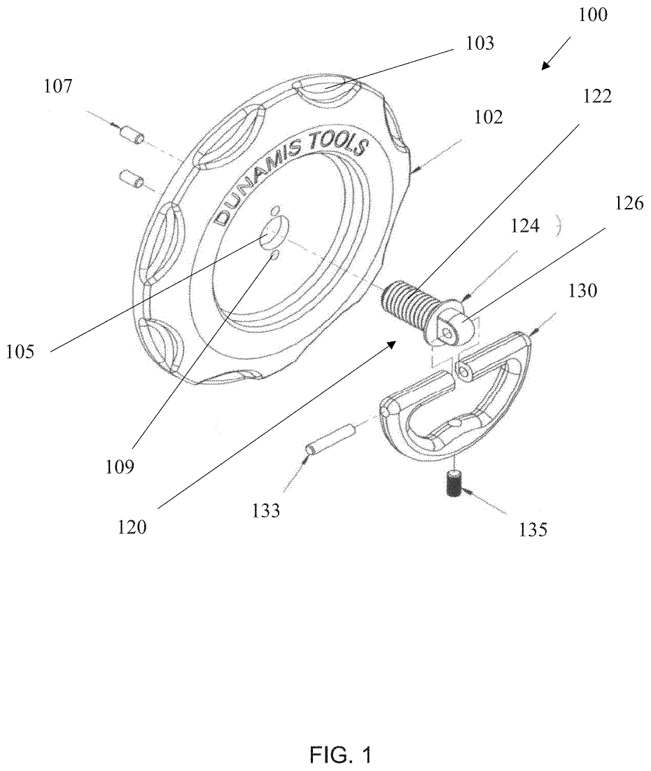

FIG. 1 is an exploded perspective view of one embodiment of the quick-change device. As shown in FIG. 1, the device 100 may comprise a grip hub 102, grips 103, bolt hole 105, dowel pins 107, pin holes 109, bolt 120, threads 122, flange 124, key connector 126, bolt key 130, bolt key pin 133, and plunger 135, which may be used to frictionally stow the key 130.

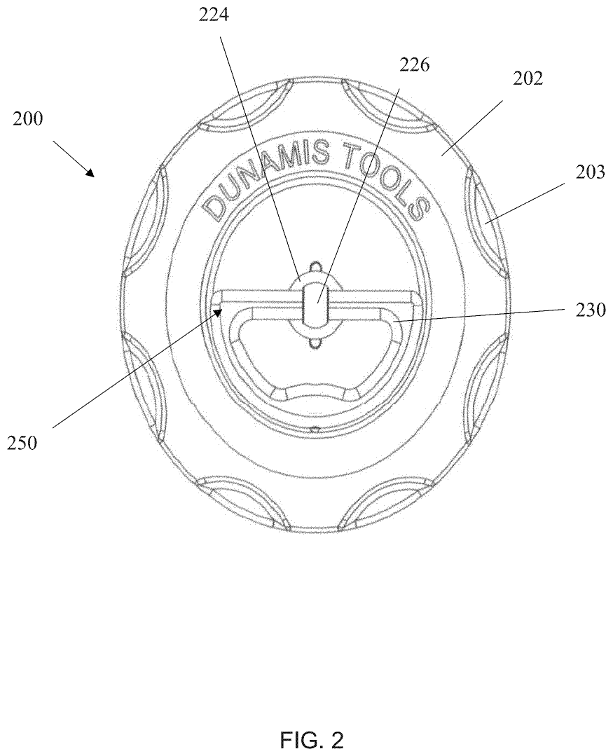

FIG. 2 is a front view of one embodiment of the quick-change device. FIG. 2 shows that the device 200 may comprise a grip hub 202, grips 203, flange 224, key connector 226, and bolt key 230. The grip hub 202 may have an indentation 250 which may allow the key connector 226 to completely and flatly collapse against the grip hub 202, such that the key connector 226 may be in a stowed position.

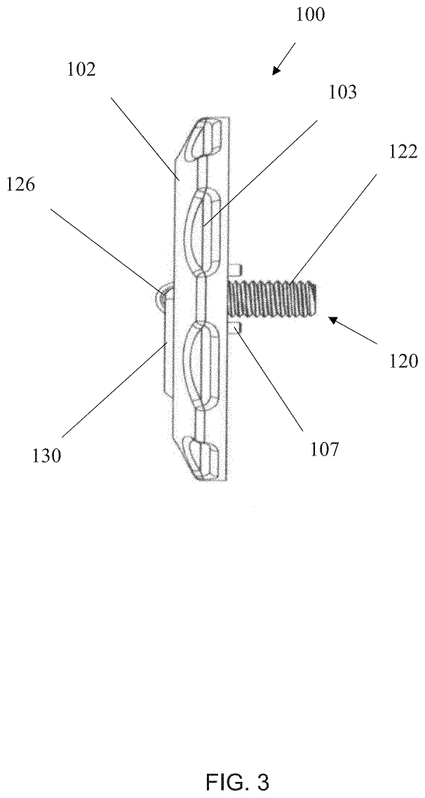

FIG. 3 is a side view of one embodiment of the quick-change device. As shown in FIG. 3, the device 100 may comprise a grip hub 102, grips 103, bolt 120, threads 122, and bolt key 130.

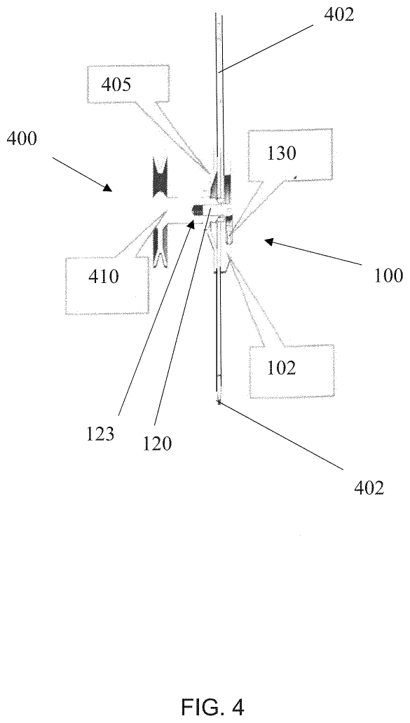

FIG. 4 is a side view of one embodiment of the quick-change device connected to a circular saw. FIG. 4 shows that the device 100 may comprise grip hub 102, bolt 120, bolt key 130, and spindle threads 123. The device may be installed on a rotary tool such as circular saw 400, which may comprise blade 402, internal hub 405, and spindle 410. The spindle threads 123 may screw into spindle 410. When the bolt 120 is removed, the blade 402 may be swapped out for a new blade.

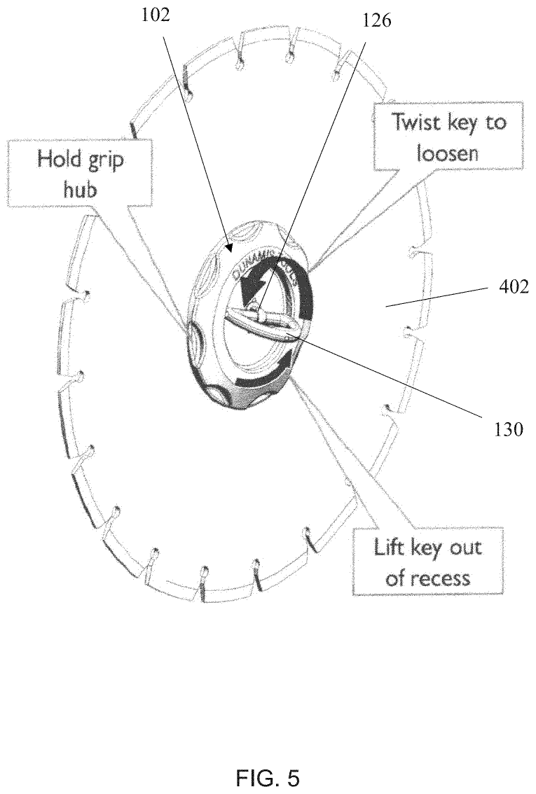

FIG. 5 is a perspective view of one embodiment of the quick-change device showing how the bolt key allows the user to unscrew the bolt without an external tool. FIG. 5 shows that the grip hub 102 may be held in place against the blade 402, the bolt key 130 may be lifted out of its collapsed position and then turned in the same direction as the saw blade rotates, typically counterclockwise for a right-handed saw. In this manner, the key 130 turns the key connector 126, such that the bolt is removed from the spindle and the blade 402 may be removed.

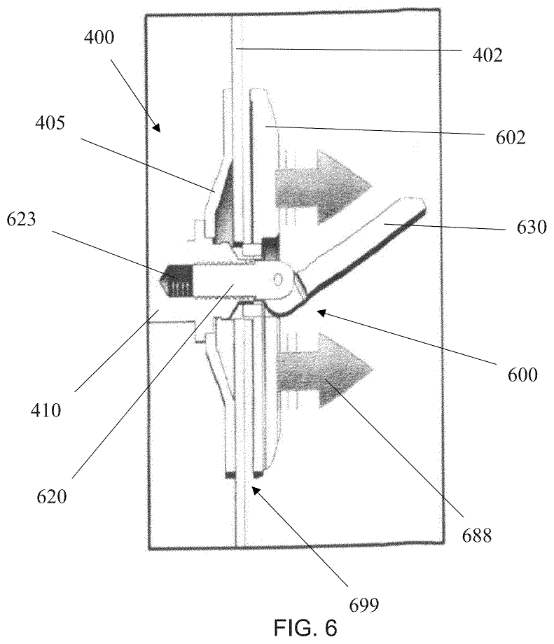

FIG. 6 is a close-up side view of a second embodiment of the quick-change device with a cam key. FIG. 6 shows that the device 600 may comprise grip hub 602, bolt 620, cam bolt key 630, and spindle threads 623. The device may be installed on circular saw 400, which may comprise blade 402, internal hub 405, and spindle 410. The spindle threads 623 may screw into spindle 410. When the bolt 620 is removed, the blade 402 may be swapped out for a new blade. The key 630 may be a cam, which, when flipped out of its collapsed placement, may release pressure on the grip hub 602, such that grip hub 602 moves 688 outward from blade 402. This is shown by space 699.

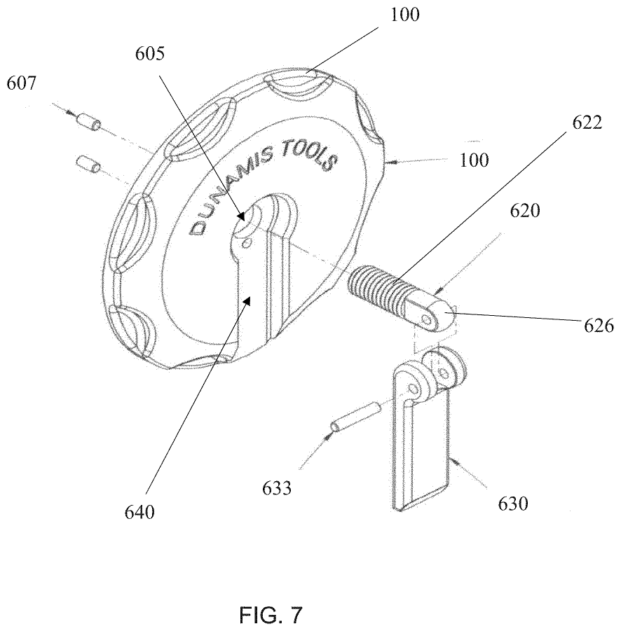

FIG. 7 is an exploded perspective view of a second embodiment of the quick-change device. As shown in FIG. 7, the device 600 may comprise a grip hub 602, grips 603, bolt hole 605, dowel pins 607, bolt 620, threads 622, key connector 626, bolt key 630, bolt key pin 633, and indentation 640.

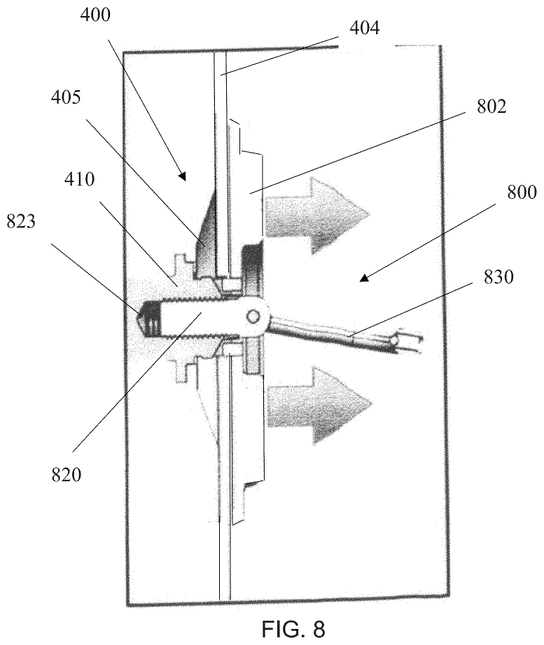

FIG. 8 is a close-up side view of a third embodiment of the quick-change device. FIG. 6 shows that the device 800 may comprise grip hub 802, bolt 820, cam bolt key 830, and spindle threads 823. The device may be installed on circular saw 400, which may comprise blade 402, internal hub 405, and spindle 410. The spindle threads 823 may screw into spindle 410. When the bolt 820 is removed, the blade 402 may be swapped out for a new blade.

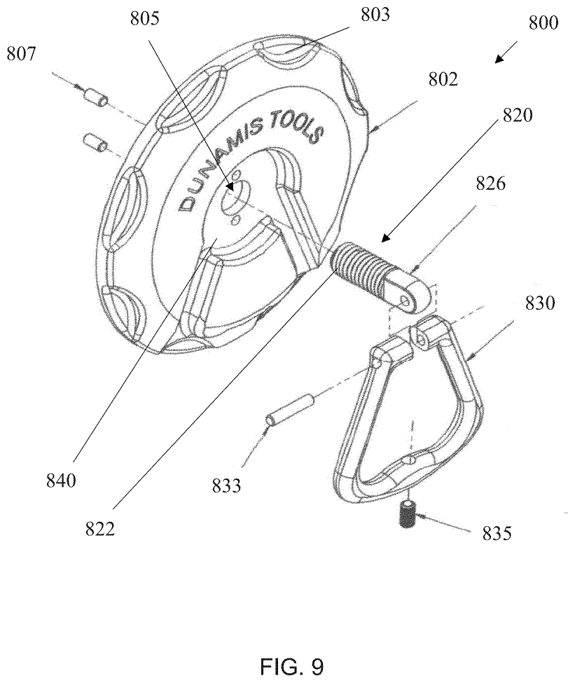

FIG. 9 is an exploded perspective view of a third embodiment of the quick-change device. As shown in FIG. 7, the device 800 may comprise a grip hub 802, grips 803, bolt hole 805, dowel pins 807, bolt 820, threads 822, key connector 826, bolt key 830, bolt key pin 833, indentation 840 and plunger 835.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A quick-change device for a circular saw, comprising:
a grip hub;
a threaded bolt;
a bolt key
wherein said bolt key is connected to said threaded bolt, such that said bolt key has at least an extended position and a collapsed position;
wherein said threaded bolt is configured to pass through a bolt hole of said grip hub and threadably connect to a spindle of a circular saw;
wherein said bolt key is configured to be able to be unscrewed from said spindle when in said extended position, such that an external tool is not needed to remove said threaded bolt from said spindle;
wherein said bolt key is configured to matingly stow next to said grip hub when said bolt key is flipped down into said collapsed position; and
wherein said threaded bolt may be quickly and safely removed and reengaged for the purpose of switching one or more saw blades.
